(19) United States
(12) Patent Application Publication
(10) Pub. No.: US 2017/0056144 A1
(43) Pub. Date: Mar. 2, 2017

(54) ORAL CAVITY WETTING SYSTEM

(71) Applicants: Mark M Levy, Raanana (IL); Shimon Spector, Matan (IL); Alexander Goryunov, Tel Aviv (IL); Arie Degani, Timrat (IL)

(72) Inventors: Mark M Levy, Raanana (IL); Shimon Spector, Matan (IL); Alexander Goryunov, Tel Aviv (IL); Arie Degani, Timrat (IL)

(21) Appl. No.: 15/120,127

(22) PCT Filed: Feb. 19, 2015
(86) PCT No.: PCT/IB2015/051281

§ 371 Date: Aug. 19, 2016

Related U.S. Application Data
(60) Provisional application No. 61/942,039, filed on Feb. 20, 2014.

(51) Int. Cl. A61C 17/02; A61C 5/14; A63B 71/08; A61J 1/10

(52) U.S. Cl. CPC A61C 17/0211; A61J 1/10; A61C 5/14; A63B 71/081; A61C 2201/007

(57) ABSTRACT

An oral cavity wetting system includes a stable detachable attachment to at least one tooth and a conduit or liquid line for delivery and storage of fluid and at least one opening for the exit of fluid inside the oral cavity.

### FIELD OF THE INVENTION

The present invention relates generally to devices and methods for the treatment of xerostomia or any other disorders related to dry mouth.

### BACKGROUND OF THE INVENTION

The oral cavity is continuously wet due to the activity of the salivary glands 24 hours a day. The saliva secretion is maintained even during sleep. Different glands work at different stages of food ingest, as a response of olfactory, visual or taste stimuli, at rest and during superficial or deep sleep. The end result is a constantly wet oral mucosa, teeth and tongue. The lubricating properties of saliva provide comfort and help protect the oral tissues against ulcers, sores, and other effects of friction. Saliva assists in food digestion, helps teeth in the remineralization process, it acts as a solvent for the taste stimuli, neutralizes acids and provides antibodies against bacterial threat.

Dry mouth, or xerostomia, occurs when there is a decreased production of saliva, most commonly as a side effect of many medications, including blood pressure medications, antihistamines, antidepressants, diuretics, nonsteroidal anti-inflammatories, and many others. In addition, other causes of dry mouth are radiation treatments to the head and neck which affects the salivary glands, diabetes, hormonal imbalance, and autoimmune disorders such as Sjögren's syndrome, rheumatoid arthritis, and systemic lupus erythematosus. Salivary production can be decreased if a major salivary duct becomes blocked or with other salivary gland diseases. Other causative factors include stress, anxiety, depression, dehydration or relative dehydration as in dry ventilated closed environment such are airplane cabins, state of coma under artificial respiration, intensive care units, etc. Extreme dry mouth and salivary gland dysfunction can produce significant and sometimes permanent mouth and throat disorders and can impair a person's quality of life, it make difficult to speak and may lead to malnutrition.

The treatment of dry mouth is directed to combat the effects of oral dryness on the teeth and oral tissues. Usually they do not cure xerostomia but provide some relief. Patients must drink water more frequently throughout the day, especially while eating. Low or non-sugar, artificially sweetened chewing gum can help stimulate salivary flow, avoiding cavities formation. The person should incorporate a low-sugar diet and begin daily use of fluoride treatments and antimicrobial alcohol-free rinses. Other remedies include medications that help increase salivary flow such as Pilocarpine and Cevimeline (that should be avoided by patients with asthma or glaucoma).

Other line of treatment incorporates the use of artificial saliva substitutes and oral lubricants containing glycerin. Usually they are supplied as a local gel or as additives to be used as needed to help to speak and during meals. There are no commercially available systems to help dry mouth sufferers at night or as a long term solution.

Addressable users for an oral cavity wetting system include xerostomia patients (permanent or temporary), radiation therapy patients or those with permanent damage of salivary glands regardless of the cause. That includes a 24 hours a day device or versions only for the night, the day or even for few hours. Patients hospitalized in the intensive care units, under artificial ventilation and exposed oral cavity to the air without ingestion of fluids, constitute another group of potential users. Occasional users include long haul airplane trips or those patients with temporary side effects of medications.

Combinations of the wetting system with drug delivery system functions increase the market segment for suitable versions of the system. In addition the wetting system can be used as a nutrition aid in patients treated with teeth wiring (that maintains the mouth closed due to jaw fractures or diet proposes).

U.S. 2008/0272153 discloses a system with a positional oral piece that includes a tube and container for fluid delivery.

U.S. 2010/0016908 discloses an oral appliance with a housing and a flexible tube for delivery of pulsed stimuli.

WO 2009/078024 discloses an oral container for pressurized fluid and a tube for continuous delivery.

WO 2013/014172 discloses an oral device for engagement with teeth, a fluid tube for its delivery.

### SUMMARY OF THE INVENTION

The present invention seeks to provide an oral cavity wetting system, as is described more in detail hereinbelow.

The invention fills the need for a device that delivers fluids to the oral cavity at a given pace without sleep disturbance or normal physiological activities, and which maintains its position inside the cavity regardless of mandibular and tongue movements.

The disclosed device includes a stable detachable attachment to at least one tooth and a conduit or liquid line, for delivery and storage of fluid (all inside or part inside and part outside the oral cavity) and at least one opening for the exit of fluid inside the oral cavity. In other embodiments the fluid can be stored in a fluid reservoir (inside or outside the oral cavity) connected to the conduit for fluid delivery or made as a part of the conduit as one piece.

### BRIEF DESCRIPTION OF THE DRAWINGS

The present invention will be understood and appreciated more fully from the following detailed description, taken in conjunction with the drawing in which:

FIGS. 1-5 are simplified perspective illustrations of oral cavity wetting systems, constructed and operative in accordance with different non-limiting embodiments of the present invention;

FIG. 6 is a simplified cutaway illustration of the oral cavity wetting system of FIG. 5, showing a fluid dripper and a stiffening element;

FIG. 7 is a simplified cutaway illustration of the fluid dripper of FIG. 6; and

FIG. 8 is a simplified pictorial illustration of a fluid reservoir useful with the oral cavity wetting system of FIG. 5.

### DETAILED DESCRIPTION OF EMBODIMENTS

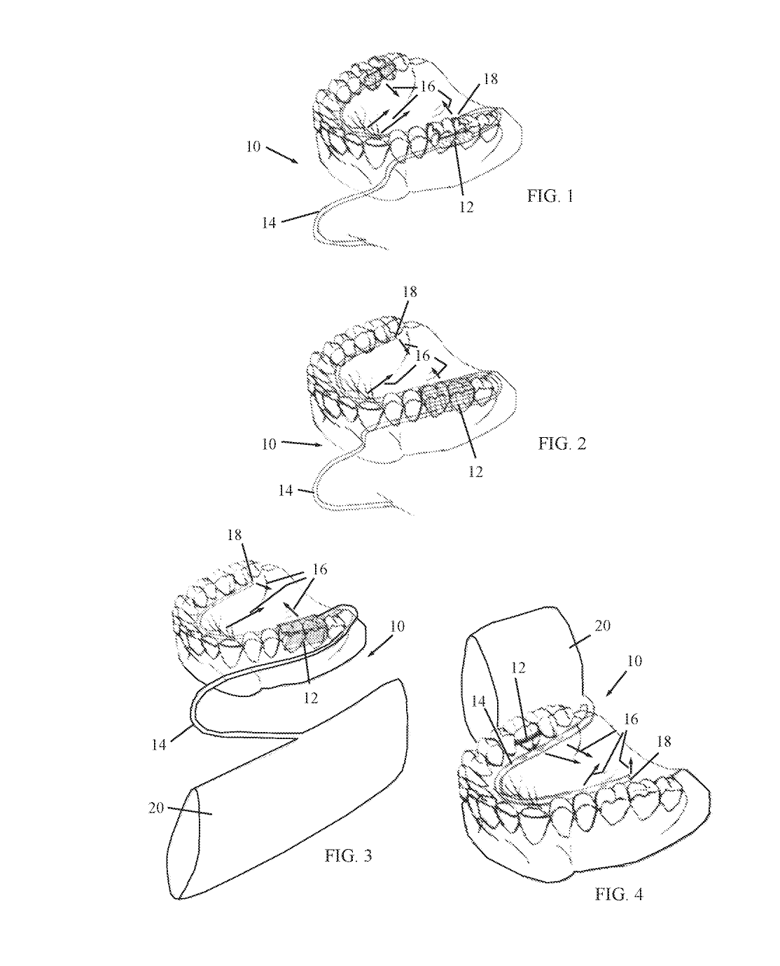

Reference is now made to FIG. 1, which illustrates an oral cavity wetting system 10, constructed and operative in accordance with a non-limiting embodiment of the present invention.

The system 10 includes a stable detachable tooth attachment 12 (also referred to as detachable attachment 12) to at least one tooth and a conduit or liquid line 14, for delivery and storage of fluid 16 (entirely inside or partially inside and partially outside the oral cavity), and at least one opening 18 for the exit of fluid 16 inside the oral cavity. In other embodiments the fluid 16 can be stored in a fluid reservoir 20 (FIG. 3 shows reservoir 20 outside the oral cavity; FIG. 4 shows it inside the oral cavity; FIG. 8 is another reservoir outside the oral cavity) connected to the conduit 14 for fluid delivery or made as a part of the conduit as one piece.

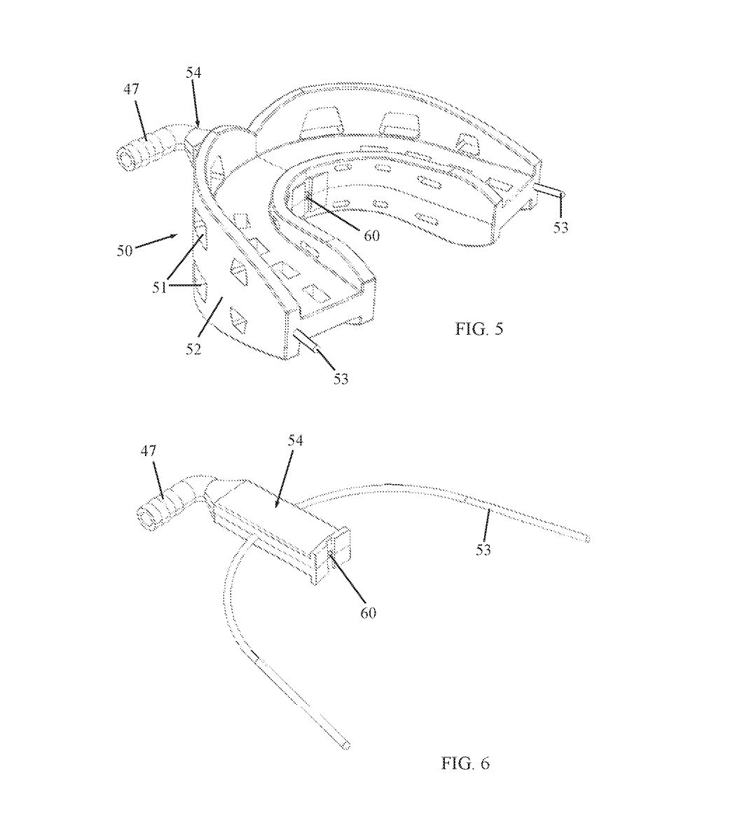

The detachable attachment 12 to the teeth includes at least one of the following: inflatable balloon-type attachment (FIG. 1); glue, an adhesive material or suitable cement (FIG. 2); mechanical snap-on clips (FIG. 3); elastic or plastic bands, sutures or fixtures, thermosetting material, light-sensitive material, a shape-memory material or a filling material or as a section of a dental brace (FIG. 4). Other embodiments includes a universal soft material mouth piece with an adjustable piece incorporated within that makes possible the personal fitting of the piece to the user tooth anatomy (described below with reference to FIG. 5). The tooth attachment 12 holds the conduit 14 that delivers the fluid 16 integrally as in one piece. In another embodiment, a separate connector affixes the tooth attachment 12 to the conduit 14. The conduit 14 is connected to the tooth attachment 12 in a rigid or a loose way (movable), to have either a fixed position (with variable conduit length) or a variable position, for optimal position of the tooth attachment 12 maintaining a fixed conduit length. The conduit 14 has one or multiple openings 18 to deliver the fluid 16 on one or different points. The conduit 14 can go from one side to the other side of the oral cavity, in the inner (lingual), outer (buccal) or both sides of the teeth.

In another embodiment, the disclosed device comprises a connection between the conduit attached to the tooth and a fluid reservoir. If the reservoir is external to the oral cavity, the connection can go out of the oral cavity exiting the mouth from any point. In a preferred embodiment, the connection will be a smooth curved section exiting the mouth from a corner of the lips, or side of the mouth, in a way sufficiently away from the corner to avoid friction and damage to the lips or the adjacent mucosa. The connection could be also exiting across the skin, in a more invasive fashion. In other embodiments, the conduit itself exits the oral cavity at any position and connects outside to the reservoir. In such an embodiment, the connection can exit the mouth at any point. The thickness of the material that forms the mouth piece between the upper and lower teeth is selected to be sufficiently large to avoid the collapse of the conduit or connection and thus prevent interrupting the fluid flow. In the case of an internal reservoir, the connection to the conduit will be inside and adjacent to the reservoir. In a more compact embodiment, the device is all intraoral with the attachment to one or more teeth, holding the conduit that expands to hold a limited amount of fluid (for instance, 15 cc inside each cheek) good for up to 5 hours or so. The expansion of the material that holds the liquid can be designed to expel the fluid at a desired rate.

Reference is now made to FIG. 5, which illustrates an oral cavity wetting system 50, constructed and operative in accordance with a non-limiting embodiment of the present invention. Oral system 50 includes a detachable buccal attachment 52 to the tooth or a group of teeth, in the superior or inferior arch, or both together, made from a soft material, oral compatible (e.g., silicone, polyurethane, etc). The walls of buccal attachment 52 may include one or more orifices 51 for fluid (gas or liquid) flow. The surfaces of the buccal attachment 52 in contact with the teeth may have variable thicknesses; this helps accommodate the device to a particular anatomy. The buccal attachment 52 is pliable so that it can be adjusted to the particular shape of the teeth of the user. A stiffening element 53 (e.g., metal wire) may be disposed in buccal attachment 52 so as to maintain the shape of buccal attachment 52 after adapting its shape to the particular user's mouth. The stiffening element 53 may be a curved wire that curvedly extends from one front end to the other front end of the attachment 52.

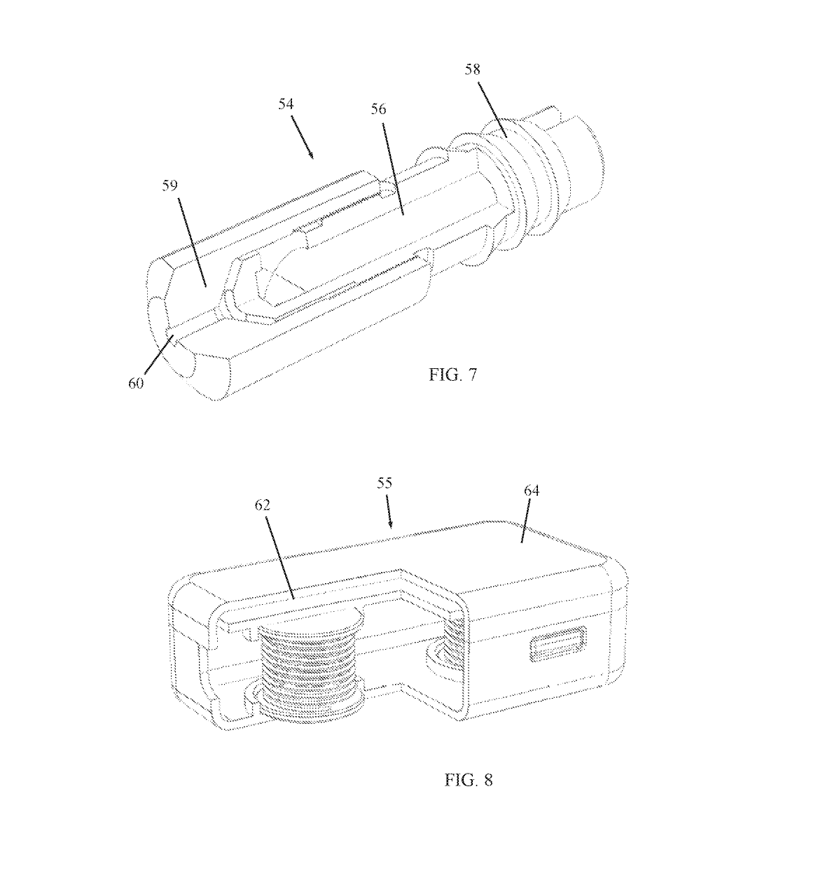

The device includes a dripper 54, which may be located between the superior and inferior arches, and which is shown more in detail in FIG. 7. The fluid flows from a reservoir 55 (FIG. 8) via an inlet 47 through dripper 54. The dripper may control the flow to be at a constant, slow fluid velocity. One way of accomplishing this is by providing dripper 54 with a controllable valve (or orifice or conduit). For example, the dripper 54 may include a fluid input conduit 56 whose fluid passageway is regulated by a screw mechanism 58. Adjusting the screw mechanism 58 (manually or by wireless control) adjusts the fluid rate of flow through conduit 56 to an internal fluid chamber 59 that ends in an small diameter outlet 60. This enables controlling the fluid flow to the inner oral cavity at a slow but constant rate (alternatively the fluid flow rate can be variable). In another embodiment, the fluid flow is pre-fixed or fixed at a certain value or in a range of values with no need for an adjusting mechanism.

FIG. 8 illustrates one type of fluid reservoir 55, which includes a deformable bag 62 that contains the fluid. The bag 62 is positioned inside a rigid box 64, which may be spring-loaded to create pressure to propel the fluid out to dripper 54 and from there to the oral cavity. In another embodiment the pressure is created by air, gas or liquid in a loaded chamber in the rigid container. A motorized or otherwise activated pump can propel the fluid in different embodiments as well.

The tooth attachment 12 is designed to complement the common anatomy and morphology of the oral cavity and relating structures for the target population. The attachment usually rests on the pre-molars and canine teeth, being the one to survive in higher percentage as opposed to molars in a common patient. In other embodiment, the tooth attachment may cover the whole tooth arch in the superior or inferior segments separately. The tooth attachment may cover both arches, superior and inferior, with a loose fit that allows opening of the mouth. In that case, the attachment remains usually in place in the lower arch, while being disengaged from the upper tooth arch. In the embodiments covering both tooth arches, superior and inferior, the material includes holes for air flow.

Due to the variance of abutment teeth, usage of one or two sided attachment types on analogic teeth allows the dental caregiver to address cases of tooth loss of different patterns. In addition, the tooth attachment will be offered in sizes to suit young and adult patients, based on population characteristics (gender, age). The width and height of the tooth-connectors will be engineered based on average sizing of the chosen teeth for the given population.

The area of the tooth attachment in direct contact to the tooth surfaces is characterized by convergence at the cervical tooth area. It has a relative angulation of 10-15 degrees to the tooth axis, due to common morphology of this area.

The geometry of the area to complement the occlusal part of the abutment teeth, in cases where the attachment covers both sided of the tooth and is connected over on its free end (cup), is formed to mimic and complement the common buccal cusps of the canines, or bicuspid form of the premolars. The design of the upper part of the tooth-attachment on its outer aspect to face opposing dentition, is complementing the common occlusion following a ‘V’, ‘U’ or saddle shaped groove that runs along the occlusal surfaces between neighboring teeth. This allows intercuspation for correct and comfortable occlusion.

The lowest point of the tooth-attachment can be placed, in the preferred embodiment but not only, 1 mm coronally to the free gingival margin to reduce trauma.

In cases of tooth-attachment with an adhesive element, a binding material will be present in the aspects facing the buccal and/or lingual aspects of the abutment teeth.

The conduit 14 or liquid line path goes from the external face of the teeth to the internal one through a loop placed distally to the dental bearing ridge, to allow articulation of opposing teeth with the appliance in situ without disturbance of the fluid flow. The suggested geometric design allows to pass the last tooth (in cases of full or partial dentition), therefore providing a comfortable and functional solution to patients, without the need for personalization or adaptations prior to usage.

In one embodiment, the conduit will be placed at the cingulum level of lower incisors, supra gingivally, approximately 1 mm above the free gingival margin. This is done to minimize local trauma associated with oral appliances who neglect to retain a safe distance, especially when it comes to dry-mouth patients and their unique vulnerability.

The placement of the liquid tube line and its intra oral path is designed to allow the closure of the mouth and lip seal to minimize interference during sleep, especially in non-mouth breathers.

The fluid reservoir is made as one piece with the conduit or liquid line but can be done as two separate pieces connected.

The fluid cavity (integral with the conduit) or a separated reservoir can be a passive container shaped in a way adapting to the anatomy of the shoulder girdle or any other region of the body for comfortable use. It can also be hanging from the shoulder or the neck (like a collar), but also can be positioned in a stand (like on an intravenous infusion set), a table or on the bed beside the user. The fluid reservoir can have propelling and/or regulation capabilities of fluid flow; can propel the fluid by the aid of a pump or any mechanical, hydraulic or pneumatic actuators. It can be made of a material that has elastic properties to be able to eject the fluid outside like a silicon or latex bag or sleeve, an elastic mesh or sleeve on top of a flexible material container that may transfer pressure to the sac, an inflatable sleeve of top of the flexible container, a spring-loaded container and other combinations. The container or the fluid cavity can be formed from a number of cavities to conform a pressure chamber designed to maintain the pressure and the flow at the same rate while the fluid content is decreasing. The inner walls of the container can also be designed in different shapes that help the maintenance of the fluid pressure to keep a continuous fluid flow. Another propelling system can be implemented by gravity when the container is hanging at a higher position than the oral cavity. In this embodiment, as in others, the flow can be controlled by a regulation attachment that reduced the effective lumen of the conduit by applying a controlled pressure on it. In any embodiment can be more than one reservoir interconnected or not, for a longer term fluid flow or can be possible to do a refill by changing the empty reservoir for a new full one.

The exit of the fluid can be regulated by a valve at the exit or any other point of the conduit, at the exit of the reservoir, at any point where a connector is used or a combination of them at any level. Fluid flow can be controlled also by a pump or any other mechanical, pneumatic or hydraulic system with or without valves. Flow can also be regulated by the diameter of the components of the system and/or the exiting holes of the conduit. The holes of the conduit are maintained closed until use, where they are uncovered by the user to allow the fluid to exit the device. The coverage of the holes can be done in a simple adhesive way resembling a sticker, can be a lid used as a wedge or screwed in to closed the hole, a plug or a piece of the same material that is weakened to be able to be detached at the time of usage leaving a hole in the conduit. In one embodiment (as in FIG. 5), the fluid flow is controlled by the configuration of the internal cavity of the conduit, with a cavity that collects the fluid just before the exit and an exit hole of a diminished diameter; the collection cavity can be fixed or variable, giving a fixed flow rate or an adjustable one.

The reservoir contains liquid that can be a saliva substitute, saline, water or any other suitable fluid. In some cases, the fluid can include other substances like drugs, vitamins, minerals, supplements, antiseptics, pH regulation materials or a combination of the former. In the case of using the system as a nutrition aid, the content will adapt to the needs (food related fluid or semi-solid preparations or other), medication, water or combinations.

The activity of the device can be monitored by transducers, gauges or any other way of measurement attached to the device, and can be storage or transmitted to a distant location wired or wireless. The measurements include, but not only, temperature, fluid flow (quantity, rate, and pattern), pH, electrolyte and ion concentration, concentration of different molecules (urea, creatinine, glucose, liver metabolites, etc.). Other measurements include degree of humidity and other physical properties of the oral cavity.

The device disclosed here can have one or more sections of it made out of edible or biodegradable material, polymers, copolymers, hydro-gels, plastics, cellulose or cellulose derivative, silicone, polyurethane, metals, although any suitable material, compatible for use in the oral cavity can be used. In one embodiment part of the system are disposable, made out of suitable materials, especially but not only the reservoir and the conduit. In addition, the dental attachment can be disposable. Part of the system can be single use or reusable.

In the claims:

1. A system for oral use that comprises:
a detachable buccal attachment to at least one tooth; and
a conduit for delivery of fluid with at least one outlet opening to deliver flowable material inside an oral cavity, wherein said buccal attachment is pliable and adjustable to a particular shape of teeth of a user, and further comprising a stiffening element disposed inside said buccal attachment configured to maintain a shape of said buccal attachment after adapting to the particular shape of teeth of the user.

2. The system according to claim 1, wherein walls of said buccal attachment comprise one or more orifices for fluid flow.

3. The system according to claim 1, wherein surfaces of said buccal attachment in contact with teeth have variable thicknesses.

4. The system according to claim 1, wherein said buccal attachment is pliable to be adjustable to a particular shape of teeth of a user.

5. The system according to claim 1, wherein said stiffening element comprises a curved wire that curvedly extends from one front end to another front end of said buccal attachment.

6. The system according to claim 1, wherein said conduit is part of a dripper that controls fluid flow through said outlet opening.

7. The system according to claim 1, wherein said dripper comprises a controllable valve.

8. The system according to claim 1, further comprising a fluid reservoir in fluid communication with said conduit.

9. The system according to claim 1, wherein said fluid reservoir is inside the oral cavity.

10. The system according to claim 1, wherein said fluid reservoir is outside the oral cavity.

11. The system according to claim 1, wherein said buccal attachment comprises an inflatable balloon attachment.

12. The system according to claim 1, wherein said buccal attachment comprises an adhesive material.

13. The system according to claim 1, wherein said buccal attachment comprises clips, bands, sutures or fixtures.

14. The system according to claim 1, wherein said buccal attachment comprises a thermosetting material, a light sensitive material, a shape memory material or a filling material.

15. The system according to claim 8, wherein said fluid reservoir contains fluid under pressure.

16. The system according to claim 8, wherein said fluid reservoir contains fluid not under pressure.
